(19) United States
(12) Patent Application Publication
(10) Pub. No.: US 2004/0011605 A1
(43) Pub. Date: Jan. 22, 2004

(54) Motor-driven parking brake apparatus

(76) Inventors: Yoshikazu Tachiiri, Chiryu-shi (JP); Asao Kozakai, Anjo-shi (JP); Jiro Kizaki, Okazaki-shi (JP)

Correspondence Address: BURNS, DOANE, SWECKER & MATHIS, L.L.P., P.O. Box 1404, Alexandria, VA, 22313-1404, US

(21) Appl. No.: 10/306,214

(22) Filed: Nov. 29, 2002

(30) Foreign Application Priority Data
Nov. 29, 2001 (JP) 2001-364845

(51) Int. Cl. F16D 65/36

(52) U.S. Cl. 188/156

(57) ABSTRACT

A motor-driven parking brake apparatus includes an electric motor and a rotation transmission mechanism. The rotation transmission mechanism brings a parking brake into a braking state through rotation in the regular direction effected by means of torque transmitted from the electric motor, and brings the parking brake into a released state through rotation in the reverse direction effected by means of the torque. The rotation transmission mechanism includes a first speed reduction mechanism, a second speed reduction mechanism, and a reverse-input cutoff clutch placed between the first and second speed reduction mechanisms. The reverse-input cutoff clutch allows its reverse-input cutoff function to be activated or deactivated through push-pull operation. When the reverse-input cutoff function is activated, the reverse-input cutoff clutch permits transmission of rotational torque from the input side of the rotation transmission mechanism to the output side of the mechanism while preventing transmission of rotational torque from the output side to the input side.

### BACKGROUND OF THE INVENTION

1. Field of the Invention

The present invention relates to a parking brake apparatus for use in a vehicle, and more particularly to a motor-driven parking brake apparatus which brings a parking brake into a braking state through rotation of a rotation transmission mechanism in a regular direction by means of torque transmitted from an electric motor serving as an input source, and into a released state through rotation of the rotation transmission mechanism in a reverse direction by means of the torque.

2. Description of the Related Art

Motor-driven parking brake apparatuses are disclosed in, for example, German Patent Application Laid-Open Nos. DE19710602A1 and DE4218717A1. In each of the motor-driven parking brake apparatuses, a rotation transmission mechanism includes a speed reduction mechanism (a screw feed mechanism). The speed reduction ratio of the speed reduction mechanism is set high (the screw pitch is set small) so as to provide a self-lock function for preventing transmission of rotational torque from the output side of the rotation transmission mechanism to the input side of the rotation transmission mechanism.

Each of the motor-driven parking brake apparatuses disclosed in the publications includes an urgent release device for urgently releasing a parking brake from a braking state; i.e., for manually releasing the parking brake in the event of an electric system failure in which the parking brake cannot be brought to a released state from a braking state by means of reverse rotation of an electric motor.

Since each of the speed reduction mechanisms employed in the disclosed motor-driven parking brake apparatuses employs a high speed reduction ratio in order to provide the self-lock function for preventing transmission of rotational torque from the output side to the input side, the transmission efficiency of the rotation transmission mechanism may decrease excessively. Therefore, in order to obtain good operating performance of the motor-driven parking brake apparatus, the size of the electric motor must be increased (a high-speed, high-torque motor must be employed) in compensation for a drop in the transmission efficiency of the rotation transmission mechanism.

Each of the urgent release devices employed in the disclosed motor-driven parking brake apparatuses employs a crank handle for manually rotating a rotary component member of the speed reduction mechanism. When the parking brake is to be released urgently, the crank handle must be rotated numerous times, thereby impairing usability. Further, a space for allowing user's rotation of the crank handle must be provided, thereby affecting convenience of mounting on a vehicle.

### SUMMARY OF THE INVENTION

An object of the present invention is to solve the above-mentioned problems in the conventional motor-driven parking brake apparatuses and to provide a motor-driven parking brake apparatus of compact size with convenience of mounting on a vehicle.

To achieve the above object, the present invention provides a motor-driven parking brake apparatus including a parking brake, an electric motor, and a rotation transmission mechanism for transmitting rotational torque from the electric motor to the parking brake. The rotation transmission mechanism brings the parking brake into a braking state when driven for rotation in a regular direction by means of the rotational torque transmitted from the electric motor, and brings the parking brake into a released state when driven for rotation in a reverse direction by means of the rotational torque. The rotation transmission mechanism includes a reverse-input cutoff clutch having a reverse-input cutoff function for preventing transmission of rotational torque from an output side of the rotation transmission mechanism to an input side of the rotation transmission mechanism.

Employment of the thus-configured reverse-input cutoff clutch obviates the need to configure the rotation transmission mechanism so as to have a self-lock function for preventing transmission of rotational torque from the output side to the input side (e.g., the need to increase the speed reduction ratio of the speed reduction mechanism provided in the rotation transmission mechanism), thereby avoiding a drop in the transmission efficiency of the rotation transmission mechanism. Since the rotation transmission mechanism does not need to have the self-lock function, the rotation transmission mechanism can be rendered compact. Also, the size of the electric motor does not need to be increased in compensation for a drop in the transmission efficiency of the rotation transmission mechanism. Thus, the motor-driven parking brake apparatus can be rendered compact.

Preferably, the rotation transmission mechanism further comprises a first speed reduction mechanism and a second speed reduction mechanism, the first and second speed reduction mechanisms being adapted to transmit rotation from the input side to the output side while reducing rotational speed; and the reverse-input cutoff clutch is interposed between the first and second speed reduction mechanisms.

In this case, rotation is transmitted from the electric motor (the input side) to the reverse-input cutoff clutch via the first speed reduction mechanism, while rotational speed is reduced by the first speed reduction mechanism, so that the reverse-input cutoff clutch is used in a low rotational speed range. Therefore, a reverse-input cutoff clutch unsuitable for use in a high rotational speed range can be employed. Further, rotation is transmitted from the parking brake (the output side) to the reverse-input cutoff clutch via the second speed reduction mechanism, while torque is decreased. Therefore, a small-sized reverse-input cutoff clutch unsuitable for use at high torque can be employed.

Preferably, the reverse-input cutoff clutch comprises a mechanism for deactivating the reverse-input cutoff function. Thus, the reverse-input cutoff function of the reverse-input cutoff clutch can be deactivated by means of the deactivating mechanism. More preferably, the deactivating mechanism includes a reaction member, and a lock mechanism. The reaction member in a nonrotatable state activates the reverse-input cutoff function, and the reaction member in a rotatable state deactivates the reverse-input cutoff function. The lock mechanism prevents or permits rotation of the reaction member. In this case, when the lock mechanism is brought into a lock state to thereby prevent rotation of the reaction member, the reverse-input cutoff function is activated. When the lock mechanism is brought into an unlock state to thereby permit rotation of the reaction member, the reverse-input cutoff function is deactivated. Thus, when the parking brake cannot be brought into a released state from a braking state by means of rotating the electric motor in the reverse direction; i.e., in the event of an electric system failure (when an urgent release is required), the reverse-input cutoff function is deactivated by means of the deactivating mechanism (e.g., by manually unlocking the lock mechanism), whereby the parking brake can be brought into the released state from the braking state without use of the electric motor.

Preferably, the lock mechanism comprises a lock member for preventing rotation of the reaction member when engaged with the reaction member at an engagement position and for permitting rotation of the reaction member when disengaged from the reaction member at a disengagement position; and an operation cable for bringing the lock member to the engagement position or the disengagement position through manual push-pull operation.

Thus, when a user is in need of urgent release of the parking brake, the user may readily unlock the lock mechanism by means of, for example, manually pulling (or pushing) the operation cable, whereby the reverse-input cutoff function of the reverse-input cutoff clutch can be deactivated; i.e., the parking brake can be brought into the released state from the braking state without use of the electric motor. Also, since the motor-driven parking brake apparatus of the present invention can be practiced through securing a small operation space for manual push-pull operation of the operation cable, the motor-driven parking brake apparatus of the present invention can be easily mounted on a vehicle.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a sectional view showing an embodiment of a motor-driven parking brake apparatus according to the present invention;

FIG. 2 is a sectional view taken along line II-II of FIG. 1;

FIG. 3 is an enlarged partial, sectional view showing a main portion of FIG. 2 as observed in a neutral state;

FIG. 4 is an enlarged partial, sectional view showing a state in which an arcuate press element of an input shaft begins to press the roller of FIG. 3 located immediately ahead along the direction of rotation;

FIG. 5 is an enlarged partial, sectional view showing a state in which, subsequently to the state of FIG. 4, the input shaft causes an output shaft to rotate;

FIG. 6 is a sectional view, equivalent to FIG. 2, showing another embodiment of a lock mechanism; and

FIG. 7 is a sectional view, equivalent to FIG. 2, showing a further embodiment of the lock mechanism.

### DESCRIPTION OF THE PREFERRED EMBODIMENT

An embodiment of the present invention will next be described in detail with reference to the drawings.

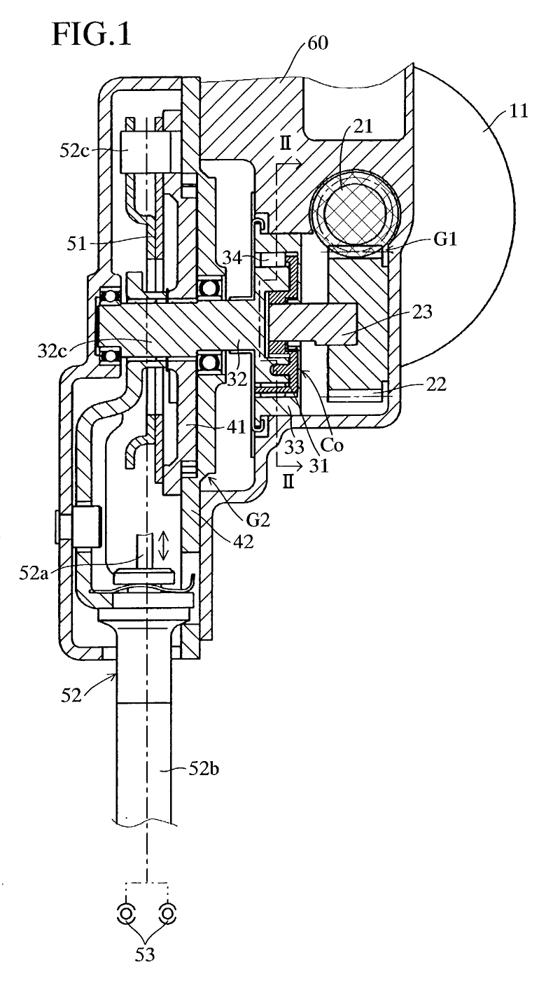

FIGS. 1 to 5 show a motor-driven parking brake apparatus according to the embodiment. The motor-driven parking brake apparatus is for use in a vehicle and is configured in the following manner. Torque of an electric motor 11 serving as an input source is transmitted to a cable guide 51 via a first speed reduction mechanism G1, a reverse-input cutoff clutch Co, and a second speed reduction mechanism G2. Rotation (circular movement) of the cable guide 51 brings a parking brake 53 into a braking state or a released state via an operation cable 52.

Under control of an electric control unit (not shown), the electric motor 11 rotates in the regular direction when a driver operates the parking brake 53 (e.g., when the driver pulls up an operation lever or steps on an operation pedal), and rotates in the reverse direction when the driver releases the parking brake 53 (e.g., when the driver returns the operation lever or the operation pedal back to its original position).

The first speed reduction mechanism G1 transmits rotation of an output shaft (not shown) of the electric motor 11 to an input shaft 31 of the reverse-input cutoff clutch Co while reducing rotational speed. The first speed reduction mechanism G1 includes a worm 21 connected coaxially to the output shaft of the electric motor 11 in a unitarily rotatable manner; a worm wheel 22 engaged with the worm 21 and rotated by the worm 21; and an output shaft 23 fitted coaxially to the worm wheel 22 in a unitarily rotatable manner.

The reverse-input cutoff clutch Co has a reverse-input cutoff function that permits transmission of rotational torque at substantially constant speed from the input side (from the first speed reduction mechanism G1) to the output side (the second speed reduction mechanism G2) and prevents transmission of rotational torque from the output side to the input side. The reverse-input cutoff clutch Co includes an input shaft 31 coupled coaxially to the output shaft 23 of the first speed reduction mechanism G1 in a unitarily rotatable manner; an output shaft 32 disposed coaxially with the input shaft 31 and rotatable by a predetermined amount in relation to the input shaft 31; an outer ring 33 rotatably disposed within a housing 60 to surround the input shaft 31 and the output shaft 32 and serving as the reaction member; four pairs of rollers 34 (eight rollers 34 in total) placed between the outer ring 33 and the input and output shafts 31 and 32; and four springs 35 each placed between the paired rollers 34 and impelling the paired rollers 34 away from each other.

The reverse-input cutoff clutch Co includes four pins 31a inserted into four corresponding holes 32a formed in the output shaft 32 such that a predetermined clearance S1 is formed between each pin 31a and the wall of the corresponding hole 32a as observed in the neutral state (the state of FIG. 3); and four arcuate press elements 31b disposed between the output shaft 32 and the outer ring 33 in such a manner as to be able to press or move away from the corresponding rollers 34 and such that a predetermined clearance S2 (S1>S2) is formed between each arcuate press element 31b and the corresponding roller 34 as observed in the neutral state.

The output shaft 32 of the reverse-input cutoff clutch Co includes the above-mentioned four holes 32a; four wedge cam faces 32b for pressing the rollers 34 toward the outer ring 33 when the output shaft 32 rotates from the neutral state in relation to the input shaft 31 and the outer ring 33; and an eccentric shaft portion 32c (see FIG. 1) supporting rotatably a movable, external gear 41 of the second speed reduction mechanism G2.

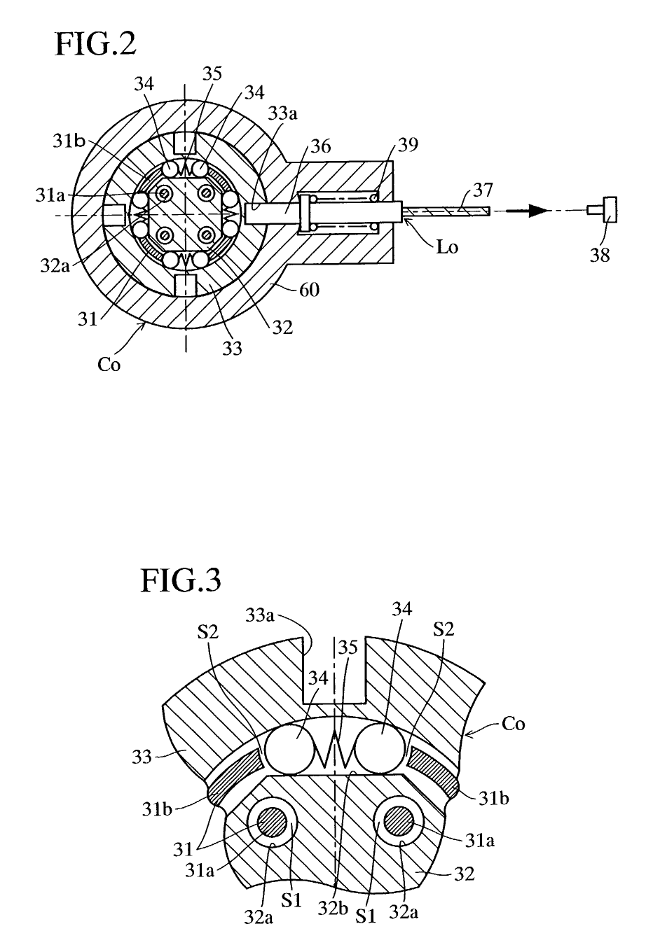

The outer ring 33 of the reverse-input cutoff clutch Co has four engagement grooves (alternatively, engagement holes) 33a formed on the outer circumferential surface thereof. When a lock mechanism Lo for urgent release of the parking brake is in the lock state; i.e., when a pole (a lock pin) 36, serving as the lock member, of the lock mechanism Lo is fitted into any one of the engagement grooves 33a (when the pole 36 is at the engagement position of FIG. 2), the outer ring 33 is not rotatable in relation to the housing 60. When the lock mechanism Lo is in the unlock state; i.e., the pole 36 is disengaged from the engagement groove 33a (when the pole 36 is at the disengagement position), the outer ring 33 is rotatable in relation to the housing 60.

When the parking brake 53 in the braking state is to be urgently released, the lock mechanism Lo is manually brought into the unlock state (a state in which the reverse-input cutoff function of the reverse-input cutoff clutch Co is deactivated) from the lock state (a state in which the reverse-input cutoff function of the reverse-input cutoff clutch Co is activated). As shown in FIG. 2, the lock mechanism Lo includes the above-mentioned pole 36, which prevents rotation of the outer ring 33 at the engagement position and permits rotation of the outer ring 33 at the disengagement position; an operation cable 37 and an operation knob 38 for allowing a driver to manually pull the pole 36 from the engagement position to the disengagement position; and a return spring 39 impelling the pole 36, the operation cable 37, and the operation knob 38 toward the engagement position.

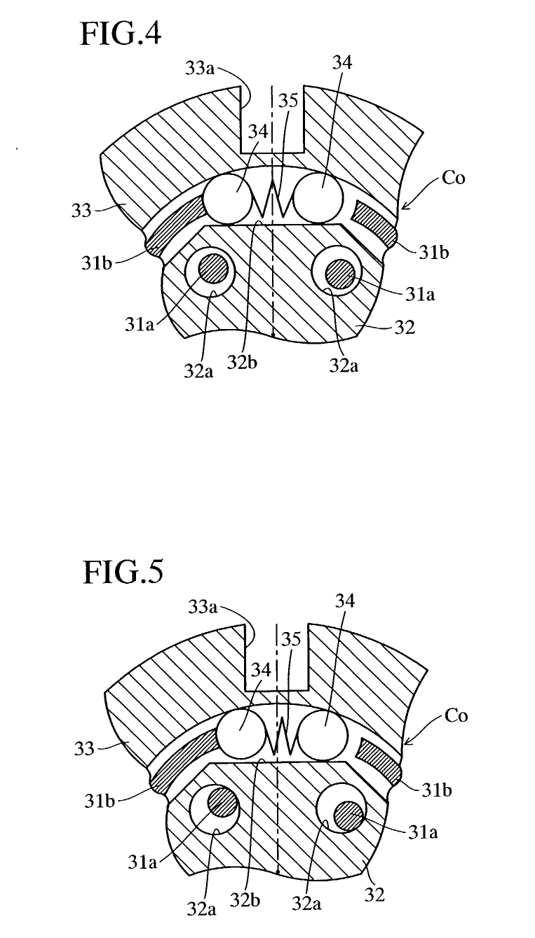

In the thus-configured reverse-input cutoff clutch Co, when the input shaft 31 is rotated in either regular or reverse direction from the neutral state of FIG. 3, the clutch Co operates in the following manner. At the initial stage of rotation; for example, in transition from the state of FIG. 4 to the state of FIG. 5, the arcuate press elements 31b of the input shaft 31 press the corresponding rollers 34 located immediately ahead along the direction of rotation against the force of the springs 35, thereby deactivating a clutch function (a function for connecting the output shaft 32 and the outer ring 33). Thus, subsequently, the input shaft 31 rotates the output shaft 32 via the four pins 31a, whereby the input shaft 31, the output shaft 32, all of the rollers 34, and all of the springs 35 are rotated in unison.

By contrast, when the output shaft 32 attempts to rotate from the neutral state of FIG. 3 in either regular or reverse direction, the upstream rollers 34 of individual pairs of rollers 34 along the direction of rotation are pressed by the corresponding wedge cam faces 32b to thereby be caught between the output shaft 32 and the outer ring 33, thereby activating the clutch function. Thus, the frictional engagement force induced between the inner circumferential surface of the outer ring 33 and the outer circumferential surface of each of the upstream rollers 34 prevents rotation of the output shaft 32. As a result, rotation is not transmitted from the output shaft 32 to the input shaft 31, whereby neither of the input shaft 31 and the output shaft 32 rotates.

The second speed reduction mechanism G2 includes a movable, external gear 41 and a stationary, internal gear 42. The movable, external gear 41 is rotatably supported by means of the eccentric shaft portion 32c of the output shaft 32 of the reverse-input cutoff clutch Co while supporting the cable guide 51 in a unitary condition. The stationary, internal gear 42 is fixedly attached to the housing 60 while being engaged with the movable, external gear 41. Speed is reduced by means of the difference in the number of teeth between the movable, external gear 41 and the stationary, internal gear 42.

The number of teeth of the movable, external gear 41 is smaller by one than that of the stationary, internal gear 42 (the number of teeth may be smaller by two or more). When the output shaft 32 of the reverse-input cutoff clutch Co makes one rotation in the regular direction as the electric motor 11 rotates in the regular direction, the movable, external gear 41 rotates in the regular direction by one tooth (by one tooth-to-tooth pitch). When the output shaft 32 makes one rotation in the reverse direction as the electric motor 11 rotates in the reverse direction, the movable, external gear 41 rotates in the reverse direction by one tooth.

The cable guide 51 is adapted to wind and unwind an inner wire 52a of the operation cable 52. When the movable, external gear 41 rotates in the regular direction, the cable guide 51 winds the inner wire 52a. When the movable, external gear 41 rotates in the reverse direction, the cable guide 51 unwinds the inner wire 52a. A connection pin 52c is fixedly attached to an end portion of the inner wire 52a while being fixedly connected to the cable guide 51.

The operation cable 52 is adapted to mechanically operate the parking brake 53 adapted to stop rotation of certain wheels. The operation cable 52 includes the above-mentioned inner wire 52a, which is fixedly connected to the cable guide 51 at one end and to an operating section (details are not shown in FIG. 1) of the parking brake 53 at the other end; and an outer tube 52b, in which the inner wire 52a is movably accommodated and which is fixedly attached at opposite ends to corresponding fixing portions of a vehicle.

The thus-configured motor-driven parking brake apparatus functions in the following manner. In the case where the electric system of the electric motor 11 is normal, a driver's operation to activate the parking brake 53 causes the electric motor 11 to rotate in the regular direction. As a result, the cable guide 51 is rotated in the regular direction via the first speed reduction mechanism G1, the reverse-input cutoff clutch Co, and the second speed reduction mechanism G2. Thus, the inner wire 52a is wound on the cable guide 51 to thereby be pulled, thereby bringing the parking brake 53 into the braking state.

The parking brake 53 is held in the braking state even when the supply of electricity to the electric motor 11 for rotating in the regular direction is stopped. Specifically, in such an event, tension acting on the inner wire 52a attempts to rotate the cable guide 51 in the reverse direction, thereby attempting to rotate the output shaft 32 of the reverse-input cutoff clutch Co in the reverse direction. However, the upstream rollers 34 of individual pairs of rollers 34 along the direction of rotation are pressed by the corresponding wedge cam faces 32b to thereby be caught between the output shaft 32 and the outer ring 33, thereby activating the clutch function. Thus, the frictional engagement force induced between the outer circumferential surface of each of the upstream rollers 34 and the inner circumferential surface of the outer ring 33-whose rotation in relation to the housing 60 is prevented by means of the lock mechanism Lo—prevents rotation of the output shaft 32. Therefore, rotation of the cable guide 51 in the reverse direction is prevented, thereby maintaining the parking brake 53 in the braking state.

In the case where the electric system of the electric motor 11 is normal, a driver's operation to release the parking brake 53 causes the electric motor 11 to rotate in the reverse direction. As a result, the cable guide 51 is rotated in the reverse direction via the first speed reduction mechanism G1, the reverse-input cutoff clutch Co, and the second speed reduction mechanism G2. Thus, the inner wire 52a is unwound from the cable guide 51 to thereby be loosened, thereby bringing the parking brake 53 into the released state.

In the event of any anomaly in the electric system of the electric motor 11 (in the event of an electric system failure), a driver's operation to release the parking brake 53 does not cause the electric motor 11 to rotate in the reverse direction, resulting in failure to release the parking brake 53. In this case, by manually pulling the operation knob 38, the driver can release the parking brake 53.

When the operation knob 38 is manually pulled, the pole 36 is caused via the operation cable 37 to move against the force of the return spring 39 from the engagement position to the disengagement position, thereby permitting rotation of the outer ring 33 of the reverse-input cutoff clutch Co in relation to the housing 60. Thus, tension acting on the inner wire 52a causes the cable guide 51, together with the movable, external gear 41, to rotate in the reverse direction, thereby causing the output shaft 32 of the reverse-input cutoff clutch Co to rotate in the reverse direction. As a result, the input shaft 31, the output shaft 32, the outer ring 33, the rollers 34, and the springs 35 of the reverse-input cutoff clutch Co rotate in unison in the reverse direction. Therefore, the cable guide 51 rotates in the reverse direction, whereby the inner wire 52a is unwound from the cable guide 51 to thereby be loosened, thereby bringing the parking brake 53 into the released state.

When, with the parking brake 53 in the released state, an anomaly in the electric system of the electric motor 11 is repaired to thereby normalize the electric system of the electric motor 11, a driver's operation to activate the parking brake 53 causes the electric motor 11 to rotate in the regular direction. Thus, the above-described braking operation (operation to establish the braking state) is conducted, thereby bringing the parking brake 53 into the braking state.

When, with the electric system of the electric motor 11 restored, the pole 36 of the lock mechanism Lo is not aligned with any one of the engagement grooves 33a formed in the outer ring 33 of the reverse-input cutoff clutch Co, and thus the force of the return spring 39 applied to the pole 36 fails to return the pole 36 to the engagement position, tension that acts on the inner wire 52a as a result of the parking brake 53 being brought into the braking state causes the outer ring 33 of the reverse-input cutoff clutch Co to rotate in the reverse direction. In the course of the reverse rotation of the outer ring 33, when the pole 36 is aligned with one of the engagement grooves 33a formed in the outer ring 33, the force of the return spring 39 causes the pole 36 to return to the engagement position, thereby disabling further rotation of the outer ring 33 in relation to the housing 60 and thus maintaining the parking brake 53 in the braking state. In this case, in order to prevent a great reduction in tension (a braking force) acting on the inner wire 52a, the four (a plurality of) engagement grooves 33a are formed on the outer circumferential surface of the outer ring 33.

As is apparent from the above description, in the present embodiment, the reverse-input cutoff clutch Co is incorporated in the rotation transmission mechanism that includes the first speed reduction mechanism G1 and the second speed reduction mechanism G2 for reducing the speed of rotation transmitted from the electric motor 11, thereby obviating the need to configure the rotation transmission mechanism so as to have a self-lock function for preventing transmission of rotational torque from the output side to the input side (e.g., the need to increase the speed reduction ratio of the speed reduction mechanisms G1 and G2), thereby avoiding a drop in the transmission efficiency of the rotation transmission mechanism. Since the rotation transmission mechanism does not need to have the self-lock function, the rotation transmission mechanism can be rendered compact. Also, the size of the electric motor does not need to be increased in compensation for a drop in the transmission efficiency of the rotation transmission mechanism. Thus, the motor-driven parking brake apparatus can be rendered compact.

In the present embodiment, rotation is transmitted from the electric motor 11 (the input side) to the reverse-input cutoff clutch Co via the first speed reduction mechanism G1, while rotational speed is reduced by the first speed reduction mechanism G1, so that the reverse-input cutoff clutch Co is used in a low rotational speed range. Therefore, a reverse-input cutoff clutch unsuitable for use in a high rotational speed range can be employed as the reverse-input cutoff clutch Co. Further, rotation is transmitted from the parking brake 53 (the output side) to the reverse-input cutoff clutch Co via the second speed reduction mechanism G2, while torque is decreased. Therefore, a small-sized reverse-input cutoff clutch unsuitable for use at high torque can be employed as the reverse-input cutoff clutch Co.

According to the present embodiment, when the lock mechanism Lo for urgent release of the parking brake 53 is brought into the lock state to thereby prevent rotation of the outer ring 33 of the reverse-input cutoff clutch Co, the reverse-input cutoff function of the reverse-input cutoff clutch Co is activated. Also, when the lock mechanism Lo is brought into the unlock state to thereby permit rotation of the outer ring 33, the reverse-input cutoff function is deactivated. Thus, when the parking brake 53 cannot be brought into the released state from the braking state by means of rotating the electric motor 11 in the reverse direction; i.e., in the event of an electric system failure (when an urgent release is required), the reverse-input cutoff function is deactivated by means of manually unlocking the lock mechanism Lo, whereby the parking brake 53 can be brought into the released state from the braking state without use of the electric motor 11.

Also, according to the present embodiment, when a driver is in need of urgent release of the parking brake 53, the driver may readily unlock the lock mechanism Lo by means of manually pulling the operation cable 37 with the operation knob 38, whereby the reverse-input cutoff function of the reverse-input cutoff clutch Co can be deactivated; i.e., the parking brake 53 can be brought into the released state from the braking state without use of the electric motor 11. Also, since the motor-driven parking brake apparatus of the present invention can be practiced through securing a small operation space for manual push-pull operation of the operation cable 37, the motor-driven parking brake apparatus of the present invention can be easily mounted on a vehicle.

According to the above-described embodiment, when the pole 36 is to be moved from the engagement position to the disengagement position, the operation cable 37 is manually pulled by use of the operation knob 38. However, in place of the operation knob 38 to be pulled, a reversal operation lever (not shown) for changing a push operation to a pull operation may be used. Specifically, the operation cable 37 is manually pulled by means of pushing the reversal operation lever, thereby moving the pole 36 from the engagement position to the disengagement position.

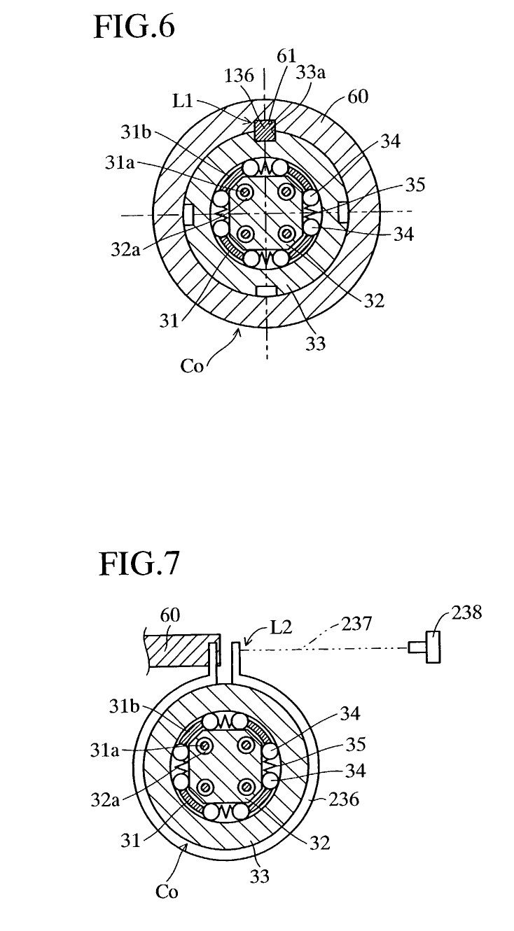

The above-described embodiment employs the lock mechanism Lo including the pole 36 as a lock member and the operation cable 37. The lock mechanism is not particularly limited so long as it includes a lock member for preventing rotation of the outer ring 33 (the reaction member) of the reverse-input cutoff clutch Co at the engagement position and for permitting rotation of the outer ring 33 at the disengagement position, and an operation cable for bringing the lock member to the engagement position or the disengagement position through manual push-pull operation. For example, a lock mechanism L1 shown in FIG. 6 or a lock mechanism L2 shown in FIG. 7 may be employed.

The lock mechanism L1 of FIG. 6 includes a lock key 136, an operation cable, an operation knob, and a return spring. The lock key 136 is fitted in an axially movable condition in a support groove 61, which is axially formed in the housing 60, while being fitted in an axially movable condition in one of the engagement grooves 33a, which are formed in the outer ring 33 of the reverse-input cutoff clutch Co. The lock key 136 prevents rotation of the outer ring 33 at an engagement position (where the lock key is engaged with one of the engagement grooves 33a) and permits rotation of the outer ring 33 at a disengaged position (where the lock key 136 is axially retreated from the engagement groove 33a to thereby be disengaged from the engagement groove 33a). The operation cable (corresponding to the operation cable 37 of the above-described embodiment) is adapted to move the lock key 136 from the engagement position to the disengagement position. The operation knob (corresponding to the operation knob 38 of the above-described embodiment) is adapted to pull the operation cable. The return spring (corresponding to the return spring 39 of the above-described embodiment) is adapted to return the lock key 136 to the engagement position from the disengagement position. Thus, the lock mechanism L1 functions in a manner substantially similar to that of the lock mechanism Lo.

The lock mechanism L2 of FIG. 7 includes a lock spring 236, an operation cable 237, and an operation knob 238. The lock spring (may be of a plurality of turns) 236 clamps/unclamps the outer ring 33 of the reverse-input cutoff clutch Co from the outside. The lock spring 236 prevents rotation of the outer ring 33 at a clamp position (where the lock spring 236 clamps the outer ring 33 from the outside) and permits rotation of the outer ring 33 at an unclamp position (where the lock spring 236 unclamps the outer ring 33). The operation cable 237 (corresponding to the operation cable 37 of the above-described embodiment) is adapted to move the lock spring 236 from the clamp position to the unclamp position. The operation knob 238 (corresponding to the operation knob 38 of the above-described embodiment) is adapted to pull the operation cable 237. The lock mechanism L2 functions in a manner substantially similar to that of the lock mechanism Lo while the number of component parts is reduced (specifically, the return spring is eliminated).

According to the above-described embodiment, the outer ring 33 of the reverse-input cutoff clutch Co and the lock mechanism Lo are used to constitutes the deactivating mechanism for deactivating the reverse-input cutoff function of the reverse-input cutoff clutch Co. However, the present invention is not limited thereto. Any other appropriate mechanism may be used to embody the reverse-input-cutoff-function deactivation mechanism.

According to the above-described embodiment, the first speed reduction mechanism G1 and the second speed reduction mechanism G2 are employed to reduce the speed of rotation transmitted from the electric motor 11 (input side) to the cable guide 51 (output side). However, the present invention is not limited thereto. Any other appropriate speed reduction mechanism may be employed.

Obviously, numerous modifications and variations of the present invention are possible in light of the above teachings. It is therefore to be understood that within the scope of the appended claims, the present invention may be practiced otherwise than as specifically described herein.

What is claimed is:

1. A motor-driven parking brake apparatus comprising:
a parking brake;
an electric motor; and
a rotation transmission mechanism for transmitting rotational torque from the electric motor to the parking brake, the rotation transmission mechanism bringing the parking brake into a braking state when driven for rotation in a regular direction by means of the rotational torque transmitted from the electric motor, and bringing the parking brake into a released state when driven for rotation in a reverse direction by means of the rotational torque;
the rotation transmission mechanism comprising a reverse-input cutoff clutch having a reverse-input cutoff function for preventing transmission of rotational torque from an output side of the rotation transmission mechanism to an input side of the rotation transmission mechanism.

2. A motor-driven parking brake apparatus according to claim 1, wherein the rotation transmission mechanism further comprises a first speed reduction mechanism and a second speed reduction mechanism, the first and second speed reduction mechanisms being adapted to transmit rotation from the input side to the output side while reducing rotational speed, and the reverse-input cutoff clutch is interposed between the first and second speed reduction mechanisms.

3. A motor-driven parking brake apparatus according to claim 1, wherein the reverse-input cutoff clutch comprises a mechanism for deactivating the reverse-input cutoff function.

4. A motor-driven parking brake apparatus according to claim 2, wherein the reverse-input cutoff clutch comprises a mechanism for deactivating the reverse-input cutoff function.

5. A motor-driven parking brake apparatus according to claim 3, wherein the deactivating mechanism comprises:
a reaction member, the reaction member in a nonrotatable state activating the reverse-input cutoff function and the reaction member in a rotatable state deactivating the reverse-input cutoff function; and
a lock mechanism for preventing or permitting rotation of the reaction member.

6. A motor-driven parking brake apparatus according to claim 4, wherein the deactivating mechanism comprises:
a reaction member, the reaction member in a nonrotatable state activating the reverse-input cutoff function and the reaction member in a rotatable state deactivating the reverse-input cutoff function; and
a lock mechanism for preventing or permitting rotation of the reaction member.

7. A motor-driven parking brake apparatus according to claim 5, wherein the lock mechanism comprises:
a lock member for preventing rotation of the reaction member when engaged with the reaction member at an engagement position and for permitting rotation of the reaction member when disengaged from the reaction member at a disengagement position; and
an operation cable for bringing the lock member to the engagement position or the disengagement position through manual push-pull operation.

8. A motor-driven parking brake apparatus according to claim 6, wherein the lock mechanism comprises:
a lock member for preventing rotation of the reaction member when engaged with the reaction member at an engagement position and for permitting rotation of the reaction member when disengaged from the reaction member at a disengagement position; and
an operation cable for bringing the lock member to the engagement position or the disengagement position through manual push-pull operation.
